(19) United States
(12) Patent Application Publication
(10) Pub. No.: US 2024/0214154 A1
(43) Pub. Date: Jun. 27, 2024

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/600,796

(22) Filed: Mar. 11, 2024

Related U.S. Application Data
(63) Continuation of application No. PCT/CN2022/118879, filed on Sep. 15, 2022.

(30) Foreign Application Priority Data
Sep. 18, 2021 (CN) 202111097423.6

(51) Int. Cl. H04L 5/00; H04B 7/06; H04W 16/28; H04W 76/20

(52) U.S. Cl. CPC H04L 5/0051; H04B 7/06968; H04W 16/28; H04W 76/20

(57) ABSTRACT

A communication node receives a first message, and the first message is used to determine a first reference signal resource set; whenever first-type radio link quality assessed based on the first reference signal resource set is worse than a first threshold, increases a first counter by 1; and transmits a first radio signal for beam management, and the first radio signal indicates a first reference signal resource; determines a second reference signal resource set from a first candidate reference signal resource pool based on at least the first reference signal resource; as a response to the first counter reaching a first value, transmits a second radio signal, the second radio signal is used for beam failure recovery, and the second radio signal indicates a second reference signal resource; the second reference signal resource belongs to the second reference signal resource set. This optimizes the beam management procedure for multi-TRP.

### CROSS REFERENCE TO RELATED APPLICATIONS

The present application is the continuation of the international patent application No. PCT/CN2022/118879, filed on Sep. 15, 2022, and claims the priority benefit of Chinese Patent Application No. 202111097423.6, filed on Sep. 18, 2021, the full disclosure of which is incorporated herein by reference.

### BACKGROUND

### Technical Field

The present application relates to transmission methods and devices in wireless communication systems, and in particular to a transmission scheme and device for beam management and link recovery.

### Related Art

Traditional Network Controlled mobility comprises cell-level mobility and beam-level mobility, where cell-level mobility depends on a Radio Resource Control (RRC) signaling and beam-level mobility does not involve an RRC signaling. Prior to 3rd Generation Partnership Project (3GPP) R16, beam-level mobility is only for beam management etc. for a cell within a single cell. 3GPP RAN #80-th meeting decided to carry out a Work Item (WI) on “Further enhancements on MIMO for NR” to support multi-beam operation with enhancements for Layer 1 (L1)/Layer 2 (L2) centric inter-cell mobility and inter-cell multi-TRP (multiple Transmit/Receive Point, mTRP).

### SUMMARY

For the NR system, 3GPP introduces the Beam Failure Recovery (BFR) mechanism, where the UE (User Equipment) assesses a reference signal set belonging to a serving cell. If a number of times an assessment result being worse than a predetermined threshold reaches a predetermined value, the BFR or Random Access (RA) procedure is triggered. To achieve inter-cell L1/L2 mobility or inter-cell mTRP, when the UE is in a serving cell, the network configures at least one additional cell to the UE for a serving cell through an RRC message, and within the coverage range of the serving cell, the UE can use a TRP of an additional cell for data transmission. The additional cell and the serving cell have different PCIs (Physical Cell Identifiers).

In the existing NR system, a reference signal resource set for a measurement used to determine whether a BFR mechanism is triggered, as well as a candidate reference signal resource set used to select a reporting, are obtained through network side configuration, and the ender device does not trigger changes to the above two reference signal resource sets. In the procedure of beam management, the ender is able to implicitly inform the base station which TRP it is under the coverage of based on a PCI associated with the reported reference signal resources. Therefore, the reference signal resources reported in the beam management procedure can be applied to BFR to improve the efficiency of the BFR procedure.

To address the above problem, the present application provides a solution. It should be noted that though the present application only took the Uu interface scenario for example in the statement above; the present application is also applicable to scenarios such as sidelink, where similar technical effects can be achieved. Additionally, the adoption of a unified solution for various scenarios contributes to the reduction of hardware complexity and costs. The present application is also applicable to other scenarios facing similar problems, such as self-organized networks, or scenarios where the central node is a non-base station node, or high-speed mobile scenarios, or for different application scenarios, such as eMBB and URLLC, where similar technical effects can also be achieved. Additionally, the adoption of a unified solution for various scenarios, including but not limited to scenarios of eMBB and URLLC, contributes to the reduction of hardware complexity and costs. If no conflict is incurred, embodiments in a first node in the present application and the characteristics of the embodiments are also applicable to a second node, and vice versa. Particularly, for interpretations of the terminology, nouns, functions and variants (if not specified) in the present application, refer to definitions given in Technical Specification (TS) 36 series, TS38 series and TS37 series of 3GPP specifications.

The present application provides a method in a first node for wireless communications, comprising:
receiving a first message, the first message being used to determine a first reference signal resource set, the first reference signal resource set comprising at least one reference signal resource; whenever first-type radio link quality assessed based on the first reference signal resource set is worse than a first threshold, increasing a first counter by 1; and
transmitting a first radio signal for beam management, the first radio signal indicating a first reference signal resource; determining a second reference signal resource set from a first candidate reference signal resource pool based on at least the first reference signal resource; as a response to the first counter reaching a first value, transmitting a second radio signal, the second radio signal being used for beam failure recovery, and the second radio signal indicating a second reference signal resource;
herein, the second reference signal resource belongs to the second reference signal resource set.

In one embodiment, one technical feature of the above method is in: the procedure of applying the first reference signal resource reported by the first radio signal for beam management to the BFR procedure goes on to influence the second reference signal resource set selected by the first node, i.e., to influence a beam set to which the reported recommended beam belongs, for embodying which TRP the first node is located under the coverage of or for embodying which TRP the first node tends to be served by.

In one embodiment, another technical feature of the above method is in: there exist two TRPs in a serving base station of the first node, namely a first TRP and a second TRP; when the first node finds through beam management procedure that a beam signal under the first TRP is better, the first node selects a candidate beam set corresponding to the first TRP to report for BFR; when the first node discovers through the beam management procedure that the beam signal under the second TRP is better, the first node selects a candidate beam set corresponding to the second TRP to report for BFR; the above method better reflects the advantages and benefits of mTRP compared to existing solutions.

According to one aspect of the present application, the first candidate reference signal resource pool comprises a first candidate reference signal resource set and a second candidate reference signal resource set; the first candidate reference signal resource set and the second candidate reference signal resource set are respectively associated with a first PCI and a second PCI; when the first reference signal resource is associated with the first PCI, the second reference signal resource set is the first candidate reference signal resource set; when the first reference signal resource is associated with the second PCI, the second reference signal resource set is the second candidate reference signal resource set.

According to one aspect of the present application, comprising:
receiving a first signal, the first signal being used to determine that a demodulation reference signal of a PDCCH (Physical Downlink Control Channel) in CORESET 0 (Control Resource Set 0) and the first reference signal resource are quasi co-located (QCL).

In one embodiment, one technical feature of the above method is in: confirming a reception of the first reference signal resource to the first node through the first signaling, and spatial reception parameters corresponding to the first reference signal resource will be used for a reception of a control signaling transmitted in CORESET #0.

According to one aspect of the present application, comprising:
receiving a second signaling in a first time-frequency resource set;
herein, the first time-frequency resource set is associated with CORESET 0, and the second reference signal resource and a demodulation reference signal comprised in the second time-frequency resource set are QCL.

In one embodiment, one technical feature of the above method is in: when the first node reports the second reference signal resource through the BFR procedure, spatial reception parameters corresponding to the second reference signal resource will be used for a reception of a control signal transmitted in CORESET #0.

According to one aspect of the present application, the second reference signal resource is the first reference signal resource, or the second reference signal resource and the first reference signal resource are QCL.

According to one aspect of the present application, comprising:
updating reference signal resources associated with a first TCI (Transmission Configuration Indicator) state to the first reference signal resource;
herein, the first radio signal is used to determine the first TCI state.

In one embodiment, one technical feature of the above method is in: the first reference signal resource reported during the beam management procedure can also be used to update reference signal resources corresponding to a TCI state, avoiding the excessive interaction between the base station and the terminal, reducing the signaling overhead, and improving the efficiency.

According to one aspect of the present application, when the first node transmits the second radio signal, the second reference signal resource is updated into the first candidate reference signal resource pool.

In one embodiment, one technical feature of the above method is in: at the same time as reporting the second reference signal resource, updating the second reference signal resource to a set of candidate reference signals for a selection of recommended reference signal resources in the subsequent BFR procedure, thus further optimizing the BFR procedure, and reducing the signaling interaction.

The present application provides a method in a second node for wireless communications, comprising:
transmitting a first message, the first message being used to determine a first reference signal resource set, the first reference signal resource set comprising at least one reference signal resource; a receiver of the first message comprising a first node; whenever first-type radio link quality assessed by the first node based on the first reference signal resource set is worse than a first threshold, increasing a first counter by 1; and
receiving a first radio signal for beam management, the first radio signal indicating a first reference signal resource; the first node determining a second reference signal resource set from a first candidate reference signal resource pool based on at least the first reference signal resource; receiving a second radio signal, the second radio signal being used for beam failure recovery, and the second radio signal indicating a second reference signal resource;
herein, the second reference signal resource belongs to the second reference signal resource set, and the first node transmits the second radio signal as a response to the first counter reaching a first value.

According to one aspect of the present application, the first candidate reference signal resource pool comprises a first candidate reference signal resource set and a second candidate reference signal resource set; the first candidate reference signal resource set and the second candidate reference signal resource set are respectively associated with a first PCI and a second PCI; when the first reference signal resource is associated with the first PCI, the second reference signal resource set is the first candidate reference signal resource set; when the first reference signal resource is associated with the second PCI, the second reference signal resource set is the second candidate reference signal resource set.

According to one aspect of the present application, comprising:
transmitting a first signaling;
herein, the first signaling is used to determine that a demodulation reference signal of a PDCCH in CORESET 0 and a first reference signal resource are QCL.

According to one aspect of the present application, comprising:
transmitting a second signaling in a first time-frequency resource set;
herein, the first time-frequency resource set is associated with CORESET 0, and the second reference signal resource and a demodulation reference signal comprised in the second time-frequency resource set are QCL.

According to one aspect of the present application, the second reference signal resource is the first reference signal resource, or the second reference signal resource and the first reference signal resource are QCL.

According to one aspect of the present application, comprising:
updating reference signal resources associated with a first TCI state to the first reference signal resource;
herein, the first radio signal is used to determine the first TCI state.

According to one aspect of the present application, when the second node receives the second radio signal, the second reference signal resource is updated into the first candidate reference signal resource pool.

The present application provides a first node for wireless communications, comprising:
a first transceiver, receiving a first message, the first message being used to determine a first reference signal resource set, the first reference signal resource set comprising at least one reference signal resource; whenever first-type radio link quality assessed based on the first reference signal resource set is worse than a first threshold, increasing a first counter by 1; and
a second transceiver, transmitting a first radio signal for beam management, the first radio signal indicating a first reference signal resource; determining a second reference signal resource set from a first candidate reference signal resource pool based on at least the first reference signal resource; as a response to the first counter reaching a first value, transmitting a second radio signal, the second radio signal being used for beam failure recovery, and the second radio signal indicating a second reference signal resource;

The present application provides a second node for wireless communications, comprising:
a third transceiver, transmitting a first message, the first message being used to determine a first reference signal resource set, the first reference signal resource set comprising at least one reference signal resource; a receiver of the first message comprising a first node; whenever first-type radio link quality assessed by the first node based on the first reference signal resource set is worse than a first threshold, increasing a first counter by 1; and
a fourth transceiver, receiving a first radio signal for beam management, the first radio signal indicating a first reference signal resource; the first node determining a second reference signal resource set from a first candidate reference signal resource pool based on at least the first reference signal resource; receiving a second radio signal, the second radio signal being used for beam failure recovery, and the second radio signal indicating a second reference signal resource;
herein, the second reference signal resource belongs to the second reference signal resource set, and the first node transmits the second radio signal as a response to the first counter reaching a first value.

In one embodiment, the present application has the following advantages over conventional schemes:
the procedure of applying the first reference signal resource reported by the first radio signal for beam management to the BFR procedure goes on to influence the second reference signal resource set selected by the first node, i.e., to influence a beam set to which the reported recommended beam belongs, for embodying which TRP the first node is located under the coverage of or for embodying which TRP the first node tends to be served by;
there exist two TRPs in a serving base station of the first node, namely a first TRP and a second TRP; when the first node finds through the beam management procedure that the beam signal under the first TRP is better, the first node selects a candidate beam set corresponding to the first TRP to report for BFR; when the first node finds through the beam management procedure that the beam signal under the second TRP is better, the first node selects a candidate beam set corresponding to the second TRP to report for BFR; the above method better reflects the advantages and benefits of mTRP compared to existing solutions;
when the first node reports the second reference signal resource through the BFR procedure, spatial reception parameters corresponding to the second reference signal resource will be used for a reception of a control signal transmitted in CORESET #0;
the first reference signal resource reported during the beam management procedure can also be used to update reference signal resources corresponding to a TCI state, avoiding excessive interaction between the base station and the terminal, reducing the signaling overhead, and improving the efficiency;
at the same time as reporting the second reference signal resource, updating the second reference signal resource to a set of candidate reference signals for a selection of recommended reference signal resources in the subsequent BFR procedure, thus further optimizing the BFR procedure, and reducing the signaling interaction.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of a first message according to one embodiment of the present application;

FIG. 6 illustrates a flowchart of a first signaling according to one embodiment of the present application;

FIG. 7 illustrates a flowchart of a second signaling according to one embodiment of the present application;

FIG. 8 illustrates a schematic diagram of an application scenario according to one embodiment of the present application;

FIG. 9 illustrates a structure block diagram of a processor in a first node according to one embodiment of the present application;

FIG. 10 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

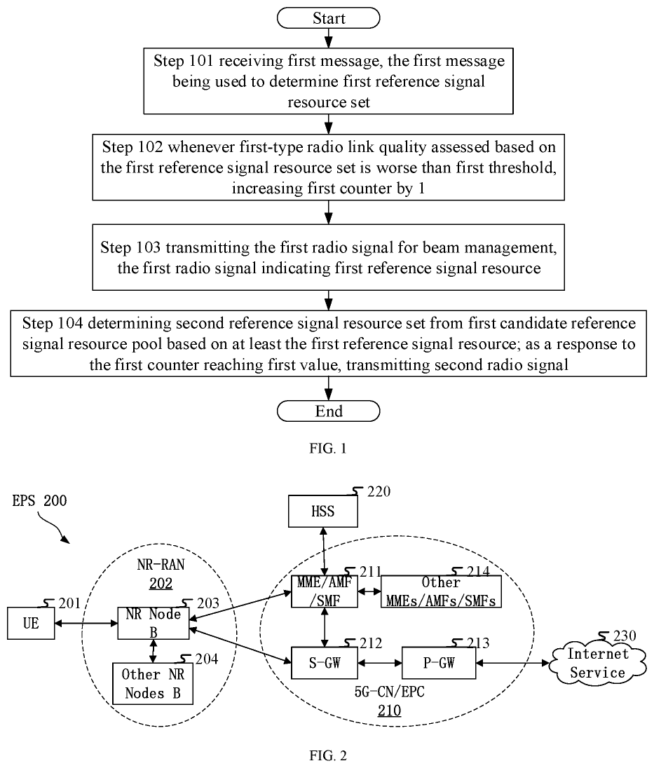

Embodiment 1 illustrates a processing flowchart of a first node, as shown in FIG. 1. In step 100 illustrated by FIG. 1, each box represents a step. In Embodiment 1, a first node in the present application receives a first message in step 101, and the first message is used to determine a first reference signal resource set; whenever first-type radio link quality assessed based on the first reference signal resource set is worse than a first threshold in step 102, increases a first counter by 1; transmits a first radio signal for beam management in step 103, the first radio signal indicates a first reference signal resource; determines a second reference signal resource set from a first candidate reference signal resource pool based on at least the first reference signal resource in step 104; as a response to the first counter reaching a first value, transmits a second radio signal.

In embodiment 1, the first reference signal resource set comprises at least one reference signal resource; the second radio signal is used for beam failure recovery, and the second radio signal indicates a second reference signal resource; the second reference signal resource belongs to the second reference signal resource set.

In one embodiment, the first message is used to implicitly indicate the first reference signal resource set.

In one embodiment, the first message is used to explicitly indicate the first reference signal resource set.

In one embodiment, a transmitter of the first message is a maintenance base station of a serving cell of the first node.

In one embodiment, the first message is transmitted via a uu interface.

In one embodiment, the first message is transmitted via a PC5 interface.

In one embodiment, a logical channel of the first message comprises a BCCH (Broadcast Control Channel), a DCCH (Dedicated Control Channel), a CCCH (Common Control Channel), an SCCH (Sidelink Control Channel), or an SBCCH (Sidelink Broadcast Control Channel).

In one embodiment, the first message comprises a Downlink (DL) signaling.

In one embodiment, the first message comprises a Sidelink (SL) signaling.

In one embodiment, the first message is an RRC message.

In one embodiment, the first message comprises at least one RRC message.

In one embodiment, the first message comprises at least one IE in an RRC message.

In one embodiment, the first message comprises at least one field in an RRC message.

In one embodiment, the first message comprises an RRCReconfiguration message.

In one embodiment, the first message comprises a System Information Block 1 (SIB1) message.

In one embodiment, the first message comprises a SystemInformation message.

In one embodiment, the first message is a field or an IE other than an IE RadioLinkMonitoringConfig.

In one embodiment, the first message comprises at least one IE other than an IE RadioLinkMonitoringConfig.

In one embodiment, the first message comprises M sub-signaling(s), and each of the M sub-signaling(s) comprises an IE RadioLinkMonitoringConfig, where M is a number of BWP(s) (Bandwidth Part(s)).

In one embodiment, the first message comprises at least one IE RadioLinkMonitoringConfig.

In one embodiment, the first message comprises at least one failureDetectionResourcesToAddModList field.

In one embodiment, the first message comprises a failureDetectionResourcesToAddModList field.

In one embodiment, at least one IE or at least one field other than an IE RadioLinkMonitoringConfig in the first message indicates the first reference signal resource set.

In one subembodiment of the embodiment, the first message comprises a ControlResourceSet IE, and at least one field in the ControlResourceSet IE indicates the first reference signal resource set.

In one subembodiment of the embodiment, the first message comprises a TCI-State IE, and at least one field in the TCI-State IE indicates the first reference signal resource set.

In one subembodiment of the embodiment, the first message comprises at least one referenceSignal field, and the at least one referenceSignal field indicates the first reference signal resource set.

In one embodiment, an IE RadioLinkMonitoringConfig in the first message is used to indicate the first reference signal resource set.

In one embodiment, an RadioLinkMonitoringRS field in the first message is used to configure a reference signal resource in the first reference signal resource set, and a purpose field of the RadioLinkMonitoringRS field is set to rlf or both.

In one embodiment, a detectionResource field in the first message is used to configure at least one of an index or type of an RS resource in the first reference signal resource set.

In one embodiment, the meaning of the phrase that the first message is used to determine a first reference signal set comprises: the first message explicitly indicates at least one reference signal resource in the first reference signal resource set.

In one embodiment, the meaning of the phrase that the first message is used to determine a first reference signal set comprises: the first message implicitly indicates at least one reference signal resource in the first reference signal resource set.

In one embodiment, the meaning of the phrase that the first message is used to determine a first reference signal set comprises: the first message is used to configure at least one reference signal resource of the first reference signal resource set.

In one embodiment, the meaning of the phrase that the first message is used to determine a first reference signal set comprises: the first message indicates at least one reference signal resource in the first reference signal resource set.

In one embodiment, the meaning of the phrase that the first message is used to determine a first reference signal set comprises: the first message indicates an index of each reference signal resource in the first reference signal resource set.

In one embodiment, the meaning of the phrase that the first message is used to determine a first reference signal set comprises: each reference signal resource in the first reference signal resource set is configured through the first message.

In one embodiment, the meaning of the phrase that the first message is used to determine a first reference signal set comprises: reference signal resources in the first reference signal resource set are reference signal resources indicated by the first message.

In one embodiment, the first reference signal resource set comprises M1 reference signal resource(s), where M1 is a positive integer not greater than M, and M is a positive integer.

In one subembodiment of the above embodiment, M is equal to 1.

In one subembodiment of the above embodiment, M is equal to 2.

In one subembodiment of the above embodiment, M is equal to 4.

In one subembodiment of the above embodiment, M is not greater than 32.

In one embodiment, at least one reference signal resource in the first reference signal resource set is a CSI-RS (Channel State Information Reference Signal) resource.

In one embodiment, at least one reference signal resource in the first reference signal resource set is an SSB (Synchronization Signal Block) resource.

In one embodiment, at least one reference signal resource in the first reference signal resource set is an SS (Synchronization Signal)/PBCH (Physical Broadcast Channel) block.

In one embodiment, at least one reference signal resource in the first reference signal resource set corresponds to a TCI-State.

In one embodiment, at least one reference signal resource in the first reference signal resource set corresponds to a TCI-StateId.

In one embodiment, any reference signal resource in the first reference signal resource set is periodic.

In one embodiment, any reference signal resource in the first reference signal resource set is aperiodic.

In one embodiment, any reference signal resource in the first reference signal resource set is QCL-Type D.

In one embodiment, a reference signal resource in the first reference signal resource set is a CSI-RS resource identified by csi-RS-Index, or the reference signal resource is an SSB resource identified by ssb-Index.

In one embodiment, a reference signal resource in the first reference signal resource set is a CSI-RS resource identified by csi-rs, or the reference signal resource is an SSB resource identified by ssb.

In one embodiment, a reference signal resource in the first reference signal resource set is a CSI-RS resource identified by NZP-CSI-RS-ResourceId, or the reference signal resource is an SSB resource identified by SSB-Index.

In one embodiment, the first reference signal resource set is used for Radio Link Monitoring (RLM).

In one embodiment, the first reference signal resource set is used for link recovery procedure.

In one embodiment, any reference signal resource in the first reference signal resource set is transmitted by a TRP of a maintenance base station of a cell identified by the first PCI in the present application.

In one embodiment, the first reference signal resource set is q̅₀.

In one embodiment, a name of the first reference signal resource set comprises q̅₀.

In one embodiment, the first reference signal resource set is configured on a BWP.

In one embodiment, the first reference signal resource set is determined through either failureDetectionResources or beamFailureDetectionResourceList.

In one embodiment, the first reference signal resource set is determined based on a reference signal set indicated in a TCI state corresponding to a CORESET used for monitoring a PDCCH (Physical Downlink Control Channel).

In one embodiment, the first reference signal resource set is determined by the first node.

In one embodiment, the meaning of the phrase that “whenever first-type radio link quality assessed based on the first reference signal resource set is worse than a first threshold, a first counter is increased by 1” comprises: first-type radio link quality assessed based on the first reference signal resource set being worse than a first threshold triggers the first counter being increased by 1.

In one embodiment, the meaning of the phrase that “whenever first-type radio link quality assessed based on the first reference signal resource set is worse than a first threshold, a first counter is increased by 1” comprises: if first-type radio link quality assessed based on the first reference signal resource set is worse than a first threshold, the first counter is increased by 1; if first-type radio link quality assessed based on the first reference signal resource set is not worse than a first threshold, the first counter is not increased by 1.

In one embodiment, the meaning of the phrase that “whenever first-type radio link quality assessed based on the first reference signal resource set is worse than a first threshold, a first counter is increased by 1” comprises: if first-type radio link quality assessed based on the first reference signal resource set is worse than a first threshold, and the first-type indication is reported to a higher layer, the first counter is only increased by 1 when the first-type indication is received by the higher layer.

In one embodiment, if the first reference signal resource set is reconfigured by a higher layer, the first counter is set to 0.

In one embodiment, if beam failure recovery timer associated with the first counter expires, the first counter is set to 0.

In one embodiment, the meaning of whenever comprises: once, or as long as, or if, or so long as.

In one embodiment, the phrase that the first-type radio link quality assessed based on the first reference signal resource set is worse than the first threshold comprises: radio link quality of all reference signal resources in the first reference signal resource set is worse than the first threshold.

In one embodiment, the phrase that the first-type radio link quality assessed based on the first reference signal resource set is worse than the first threshold comprises: radio link quality for each reference signal resource in the first reference signal resource set is lower than the first threshold.

In one embodiment, the phrase that the first-type radio link quality assessed based on the first reference signal resource set is worse than the first threshold comprises: radio link quality for each reference signal resource in the first reference signal resource set is greater than the first threshold.

In one embodiment, the first-type radio link quality is assessed based on the first reference signal resource set in each assessment period.

In one embodiment, the assessment period for the first-type radio link quality comprises at least one time unit.

In one embodiment, the time unit comprises at least one of slot, or subframe, or radio frame, or frame, or multiple Orthogonal Frequency Division Multiplexing (OFDM) symbols, or multiple Single Carrier Frequency Division Multiple Access (SC-FDMA) symbols.

In one embodiment, the time unit comprises a time interval of at least 1 millisecond (ms).

In one embodiment, the assessment period for the first-type radio link quality is one frame.

In one embodiment, the assessment period for the first-type radio link quality is one radio frame.

In one embodiment, the first threshold is configurable.

In one embodiment, the first threshold is pre-configured.

In one embodiment, the first threshold is configured through an RRC message.

In one embodiment, the first threshold comprises a Block Error Ratio (BLER) threshold.

In one embodiment, the first threshold comprises an RSRP (Reference Signal Received Power) threshold.

In one embodiment, the first threshold comprises an RSRQ (Reference Signal Received Quality) threshold.

In one embodiment, the first threshold comprises an SNR (Signal to Noise Ratio) threshold.

In one embodiment, the first threshold comprises a SINR (Signal to Interference plus Noise Ratio) threshold.

In one embodiment, the first threshold is measured by dBm.

In one embodiment, the first threshold is measured by dB.

In one embodiment, the first threshold comprises Qₒᵤₜ.

In one embodiment, the first threshold is indicated by a field in an RRC message.

In one embodiment, the first threshold is indicated by a field in an RRC message, and a name of the field comprises rlmInSyncOutOfSyncThreshold.

In one embodiment, the first threshold is indicated by a field in an RRC message, and a name of the field comprises rsrp-ThresholdSSB.

In one embodiment, the first threshold is indicated by a field in an RRC message, and a name of the field comprises rsrp-ThresholdBFR.

In one embodiment, whenever first-type radio link quality assessed based on the first reference signal resource set is worse than a first threshold, a first-type indication is reported to a target higher layer in a reporting period corresponding to the assessment period.

In one embodiment, the reporting period for the first-type radio link quality comprises at least one slot.

In one embodiment, the reporting period for the first-type radio link quality is 2 milliseconds.

In one embodiment, the reporting period for the first-type radio link quality is 10 milliseconds.

In one embodiment, the reporting period for the first-type radio link quality is a shortest period for all reference signal resources in the first reference signal resource set.

In one embodiment, the behavior of reporting a first-type indication to the target higher layer comprises: the PHY layer of the first node transmits the first-type indication to the target higher layer of the first node through an interlayer interface.

In one embodiment, the behavior of reporting a first-type indication to the target higher layer comprises: transmitting the first-type indication to the target higher layer.

In one embodiment, the behavior of reporting a first-type indication to the target higher layer comprises: informing the first-type indication to the target higher layer.

In one embodiment, the first-type indication is used to indicate to the target higher layer that first-type radio link quality assessed based on the first reference signal resource set is worse than a first threshold.

In one embodiment, the first-type indication is used to indicate beam failure to the target higher layer.

In one embodiment, the first-type indication is a beam failure instance indication.

In one embodiment, the first-type indication is for a cell identified by the first PCI.

In one embodiment, whenever first-type radio link quality assessed based on the first reference signal resource set is worse than a first threshold, physical layer of the first node reports the first-type indication to a target higher layer of the first node, and as a response to receiving the first-type indication at the target higher layer at the first node, the first counter is increased by 1.

In one embodiment, the behavior of “increasing a first counter by 1” comprises: increasing a value of the first counter by 1.

In one embodiment, the behavior of “increasing a first counter by 1” comprises: increment the first counter by 1.

In one embodiment, the first counter is used to count a number of first-type indication(s).

In one embodiment, the first counter is BFI_COUNTER.

In one embodiment, a name of the first counter comprises at least one of BFI, COUNTER, TRP, RS, Set, per, or Per.

In one embodiment, the first counter is for a cell identified by the first PCI.

In one embodiment, the first counter is for a TRP in a cell identified by the first PCI.

In one embodiment, the first counter is configured in the first node.

In one embodiment, the first counter is a counter belonging to the first node.

In one embodiment, the first-type radio link quality comprises at least one of RSRP, RSRQ, RSSI (Received Signal Strength Indicator), SNR, or SINR.

In one embodiment, the first-type radio link quality refers to quality between radio links.

In one embodiment, the first-type radio link quality is quality between a maintenance base station of a cell identified by the first PCI and the first node.

In one embodiment, the first-type radio link quality is quality between at least one TRP in a cell identified by the first PCI and the first node.

In one embodiment, the first-type radio link quality is quality between all TRPs in a cell identified by the first PCI and the first node.

In one embodiment, the beam management in the application comprises beam management based on network control.

In one embodiment, the beam management in the application comprises beam management based on the second node control.

In one embodiment, the beam management in the present application comprises beam management initiated by the first node.

In one embodiment, the beam management in the present application comprises beam management initiated by the UE.

In one embodiment, the beam management procedure in the present application comprises beam management.

In one embodiment, the beam management in the present application does not belong to the beam failure detection and recovery procedure.

In one embodiment, the beam management in the present application does not belong to the beam failure detection procedure.

In one embodiment, the beam management in the present application does not belong to the beam failure recovery procedure.

In one embodiment, the beam management in the present application does not comprise: receiving an indication from a lower layer.

In one embodiment, the beam management in the present application does not comprise: as a response to receiving an indication from a lower layer, starting or restarting a timer.

In one embodiment, the beam management in the present application does not comprise: as a response to receiving an indication from a lower layer, increasing a counter by 1.

In one embodiment, the beam management in the present application does not comprise: when first-type radio link quality assessed based on the first reference signal resource set is worse than a first threshold, increasing a first counter by 1.

In one embodiment, the beam management in the present application does not depend on an evaluation of the first reference signal resource set.

In one embodiment, the beam management in the present application does not depend on whether the first counter reaches a given value.

In one embodiment, the beam management in the present application does not depend on the beam failure detection procedure.

In one embodiment, the beam management in the present application comprises beam refinement.

In one embodiment, the beam management in the present application comprises beam tracking.

In one embodiment, the beam management in the present application comprises beam adjustment.

In one embodiment, the beam management in the present application comprises beam-level mobility.

In one embodiment, the beam management in the present application comprises beam handover.

In one embodiment, the beam management in the present application comprises beam change.

In one embodiment, the beam management in the present application comprises beam switch.

In one embodiment, the beam management in the present application comprises beam measurement.

In one embodiment, the beam management in the present application comprises beam reporting.

In one embodiment, the beam management in the present application comprises changing a QCL relation of a reference signal resource.

In one embodiment, the beam management in the present application comprises changing a TCI state of a physical channel.

In one embodiment, the beam management in the present application comprises changing a TCI state corresponding to a CORESET of a physical channel.

In one embodiment, the beam management in the present application comprises changing a corresponding relation between a TCI and a reference signal resource.

In one embodiment, the beam management in the present application comprises CSI (Channel State Information) reporting.

In one embodiment, the beam management in the present application comprises Beam Level Measurement.

In one embodiment, the beam management in the present application comprises beam-level mobility.

In one embodiment, the beam management in the present application does not require explicit RRC signaling to be triggered.

In one embodiment, the beam management in the present application comprises beam adjustment below the RRC layer.

In one embodiment, the beam management in the present application does not comprise BFR.

In one embodiment, the beam management mentioned in the present application does not comprise cell-level mobility management.

In one embodiment, the first radio signal is transmitted through UCI (Uplink Control Information).

In one embodiment, a physical-layer channel occupied by the first radio signal comprises a PUSCH (Physical Uplink Shared Channel) transmission.

In one embodiment, the first radio signal is CSI.

In one embodiment, the first radio signal is transmitted through beam management procedure.

In one embodiment, the first radio signal implicitly indicates a first reference signal resource.

In one subembodiment of the embodiment, at least one of a location of frequency-domain resources occupied by or a location of time-domain resources occupied by the first radio signal is used to indicate the first reference signal resource.

In one subembodiment of the embodiment, a scrambling code adopted by a demodulation reference signal comprised in the first radio signal is used to indicate the first reference signal resource.

In one embodiment, the first radio signal explicitly indicates a first reference signal resource.

In one embodiment, the first reference signal resource is a CSI-RS resource.

In one embodiment, the first reference signal resource is an SSB resource.

In one embodiment, the first reference signal resource is an SS/PBCH (Physical Broadcast Channel) block.

In one embodiment, the first reference signal resource corresponds to a TCI-State.

In one embodiment, the first reference signal resource corresponds to a TCI-StateId.

In one embodiment, radio channel quality determined by the first node based on a reference signal transmitted in the first reference signal resource is greater than a second threshold, the second threshold is fixed or configured through an RRC signaling.

In one subembodiment of the embodiment, the second threshold comprises a BLER threshold.

In one subembodiment of the embodiment, the second threshold comprises an RSRP threshold.

In one subembodiment of the embodiment, the second threshold comprises an RSRQ threshold.

In one subembodiment of the embodiment, the second threshold comprises an SNR threshold.

In one subembodiment of the embodiment, the second threshold comprises an SINR threshold.

In one subembodiment of the embodiment, the second threshold is measured by dBm.

In one subembodiment of the embodiment, the second threshold is measured by dB.

In one embodiment, the meaning of the phrase of determining a second reference signal resource set from a first candidate reference signal resource pool based on at least the first reference signal resource comprises: the first node transmits a first radio signal, and after receiving feedback for the first radio signal, determines a second reference signal resource set from a first candidate reference signal resource pool based on the first reference signal resource.

In one subembodiment of the above embodiment, the feedback for the first radio signal is transmitted by the second node in the present application.

In one subembodiment of the above embodiment, the feedback for the first radio signal is transmitted by at least one TRP in a cell identified by the first PCI.

In one subembodiment of the above embodiment, the feedback for the first radio signal comprises HARQ-ACK (Hybrid Automatic Repeat reQuest Confirmation).

In one subembodiment of the above embodiment, the feedback for the first radio signal comprises a PDCCH (Physical Downlink Control Channel).

In one subembodiment of the above embodiment, the feedback for the first radio signal comprises a MAC (Medium Access Control) CE (Control Element).

In one subembodiment of the embodiment, the physical-layer channel occupied by the feedback for the first radio signal comprises a PDSCH (Physical Downlink Shared Channel).

In one subembodiment of the embodiment, the feedback for the first radio signal is used to determine that the first reference signal resource is QCL with demodulation reference signal resources of a PDCCH in CORESET#0.

In one subembodiment of the embodiment, the feedback for the first radio signal is used to determine that spatial reception parameters corresponding to the first reference signal resource can be used for a demodulation of a PDCCH in CORESET #0.

In one embodiment, the meaning of the phrase of determining a second reference signal resource set from a first candidate reference signal resource pool based on at least the first reference signal resource comprises: after the first node transmits a first radio signal and determines that the first reference signal resource and demodulation reference signal resources of a PDCCH in CORESET #0 are QCL, determining a second reference signal resource set from a first candidate reference signal resource pool based on a first reference signal resource.

In one embodiment, the meaning of the phrase of determining a second reference signal resource set from a first candidate reference signal resource pool based on at least the first reference signal resource comprises: after the first node transmits a first radio signal and determines that spatial reception parameters corresponding to the first reference signal resource can be used for a demodulation of a PDCCH in CORESET #0, determining a second reference signal resource set from a first candidate reference signal resource pool based on the first reference signal resource.

In one embodiment, the reference signal resources in the present application are CSI-RS resources.

In one embodiment, the reference signal resources in the present application are SSB resources.

In one embodiment, the reference signal resource in the present application is an SS/PBCH (Physical Broadcast Channel) block.

In one embodiment, the reference signal resource in the present application corresponds to a TCI-State.

In one embodiment, the reference signal resource in the present application corresponds to a TCI-StateId.

In one embodiment, the first candidate reference signal resource pool comprises Q candidate reference signal resource set, where Q is a positive integer greater than 1, and any candidate reference signal resource set in the Q candidate reference signal resource sets comprises at least one reference signal resource.

In one subembodiment of the embodiment, Q is equal to 2, and the Q candidate reference signal resource sets are respectively a first candidate reference signal resource set and a second candidate reference signal resource set.

In one subsidiary embodiment of the subembodiment, the first candidate reference signal resource set is associated with the first PCI.

In one subsidiary embodiment of the subembodiment, the second candidate reference signal resource set is associated with the second PCI.

In one subsidiary embodiment of the subembodiment, the second reference signal resource set is one of the first candidate reference signal resource set or the second candidate reference signal resource set.

In one subembodiment of the embodiment, Q is greater than 2, and the Q candidate reference signal resource set are respectively associated with Q different PCIs.

In one subsidiary embodiment of the subembodiment, the second reference signal resource set is one of the Q candidate reference signal resource sets.

In one embodiment, the first candidate reference signal resource pool is q₁.

In one embodiment, a name of the first candidate reference signal resource pool comprises q₁.

In one embodiment, the first candidate reference signal resource pool is configured on a BWP.

In one embodiment, the first candidate reference signal resource pool is configured through BeamFailureRecoveryConfigIE.

In one embodiment, a name of an RRC signaling for configuring the first candidate reference signal resource pool comprises Beam.

In one embodiment, a name of an RRC signaling for configuring the first candidate reference signal resource pool comprises Failure.

In one embodiment, a name of an RRC signaling for configuring the first candidate reference signal resource pool comprises Recovery.

In one embodiment, the first candidate reference signal resource pool is configured through candidateBeamRSList in TS 38.331.

In one embodiment, the first candidate reference signal resource pool is configured through candidateBeamResourceList in TS 38.331.

In one embodiment, the second radio signal is a MAC CE.

In one embodiment, a physical-layer channel occupied by the second radio signal comprises a PRACH (Physical Random Access Channel)

In one embodiment, a physical-layer channel occupied by the second radio signal comprises a PUSCH.

In one embodiment, all reference signal resources that may be selected as the second reference signal resource consist the second reference signal resource set.

In one embodiment, the beam management does not comprise the beam failure recovery.

In one embodiment, the first counter is a BFI_COUNTER, and any BFI_COUNTER is not used to trigger the first radio signal.

In one embodiment, the second reference signal resource is a CSI-RS resource.

In one embodiment, the second reference signal resource is an SSB resource.

In one embodiment, the second reference signal resource is an SS/PBCH (Physical Broadcast Channel) block.

In one embodiment, the second reference signal resource corresponds to a TCI-State.

In one embodiment, the second reference signal resource corresponds to a TCI-StateId.

In one embodiment, the second reference signal resource is q_{new}.

In one embodiment, the second radio signal implicitly indicates a second reference signal resource.

In one subembodiment of the embodiment, at least one of a location of frequency-domain resources occupied by or a location of time-domain resources occupied by the second radio signal is used to indicate the second reference signal resource.

In one subembodiment of the embodiment, a scrambling code adopted by a demodulation reference signal comprised in the second radio signal is used to indicate the second reference signal resource.

In one subembodiment of the embodiment, a generation of the second radio signal sequence is used to indicate the second reference signal resource.

In one embodiment, the second radio signal explicitly indicates a second reference signal resource.

In one embodiment, time-frequency resources occupied by the first radio signal are configured through an RRC signaling.

In one embodiment, time-frequency resources occupied by the first radio signal are periodic.

### Embodiment 2

Embodiment 2 illustrates a schematic diagram of a network architecture, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise UE 201, an NR-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NR-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 is a UE.

In one embodiment, the UE 201 is an ender.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB), or a gNB, or an eNB, or a ng-eNB, or an en-gNB, or a UE, or a relay, or a gateway, or at least one TRP.

In one embodiment, the node 203 comprises at least one TRP.

In one embodiment, the node 203 comprises at least one TRP in a cell identified by the first PCI, and the node 203 comprises at least one TRP in a cell identified by the second PCI.

In one embodiment, the node 203 is a logical node.

In one embodiment, different structures in the node 203 are located in a same entity.

In one embodiment, different structures in the node 203 are located in different entities.

In one embodiment, the UE supports Terrestrial Network (TN) transmission.

In one embodiment, the UE supports Non-Terrestrial Network (NTN) transmission.

In one embodiment, the UE supports communications within networks with large latency differences.

In one embodiment, the UE supports Dual Connection (DC) transmission.

In one embodiment, the UE supports NR.

In one embodiment, the UE supports UTRA.

In one embodiment, the UE supports EUTRA.

In one embodiment, the UE comprises a device supporting transmission with low-latency and high-reliability.

In one embodiment, the UE comprises an aircraft, or a vehicle terminal, or a vessel, or an IoT terminal, or an industrial IoT terminal, or a testing device, or a signalling tester.

In one embodiment, the base station supports transmission over an NTN.

In one embodiment, the base station supports transmission over networks with large latency differences.

In one embodiment, the base station supports transmission over a TN.

In one embodiment, the base station comprises a base station supporting large latency differences.

In one embodiment, the base station comprises a Marco Cellular base station, a Micro Cell base station, a Pico Cell base station, or a Femtocell.

In one embodiment, the base station comprises a flight platform equipment, or a satellite equipment, or a TRP (Transmitter Receiver Point), or a CU (Centralized Unit), or a DU (Distributed Unit), or a testing equipment, or a signaling tester, or an IAB (Integrated Access and Backhaul)-node, or an IAB-donor, or an IAB-donor-CU, or an IAB-donor-DU, or an IAB-DU, or an IAB-MT.

In one embodiment, the relay comprises a relay, L3 relay, L2 relay, router, or switch.

### Embodiment 3

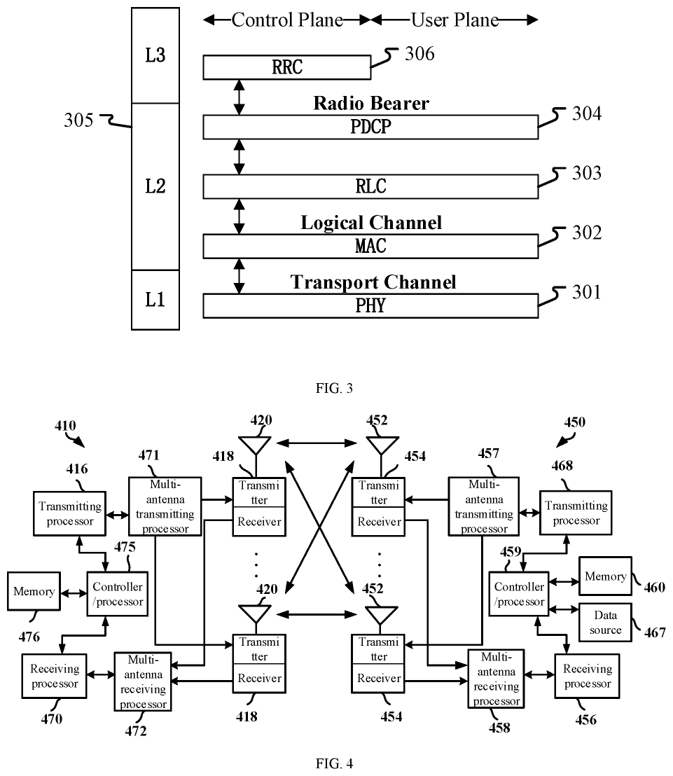

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first communication node and the second communication node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and also provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used for generating scheduling of the first communication node.

In one embodiment, the PDCP 354 of the second communication node is used for generating scheduling of the first communication node.

In one embodiment, the first message in the present application is generated by the RRC 306.

In one embodiment, the first message in the present application is generated by the MAC 302 or the MAC 352.

In one embodiment, the first message in the present application is generated by the PHY 301 or the PHY 351.

In one embodiment, the first radio signal in the present application is generated by the RRC 306.

In one embodiment, the first radio signal in the present application is generated by the MAC 302 or the MAC 352.

In one embodiment, the first radio signal in the present application is generated by the PHY 301 or the PHY 351.

In one embodiment, the second radio signal in the present application is generated by the RRC 306.

In one embodiment, the second radio signal in the present application is generated by the MAC 302 or the MAC 352.

In one embodiment, the second radio signal in the present application is generated by the PHY 301 or the PHY 351.

In one embodiment, the first signaling in the present application is generated by the MAC 302 or the MAC 352.

In one embodiment, the first signaling in the present application is generated by the PHY 301 or the PHY 351.

In one embodiment, the second signaling in the present application is generated by the RRC 306.

In one embodiment, the second signaling in the present application is generated by the MAC 302 or the MAC 352.

In one embodiment, the second signaling in the present application is generated by the PHY 301 or the PHY 351.

In one embodiment, the first node is a terminal.

In one embodiment, the second node is a terminal.

In one embodiment, the second node is a Transmitter Receiver Point (TRP).

In one embodiment, the second node is a cell.

In one embodiment, the second node is an eNB.

In one embodiment, the second node is a base station.

In one embodiment, the second node is used to manage multiple TRPs.

In one embodiment, the second node is a node used for managing multiple cells.

In one embodiment, the second node is a node used for managing multiple carriers.

### Embodiment 4

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: first receives a first message, the first message is used to determine a first reference signal resource set, the first reference signal resource set comprises at least one reference signal resource; whenever first-type radio link quality assessed based on the first reference signal resource set is worse than a first threshold, increases a first counter by 1; then transmits a first radio signal for beam management, the first radio signal indicates a first reference signal resource; determines a second reference signal resource set from a first candidate reference signal resource pool based on at least the first reference signal resource; as a response to the first counter reaching a first value, transmits a second radio signal, the second radio signal is used for beam failure recovery, and the second radio signal indicates a second reference signal resource; the second reference signal resource belongs to the second reference signal resource set.

In one embodiment, the first communication device 450 comprises at least one processor and at least one memory. a memory that stores a computer readable instruction program. The computer readable instruction program generates an action when executed by at least one processor. The action includes: first receiving a first message, the first message being used to determine a first reference signal resource set, the first reference signal resource set comprising at least one reference signal resource; whenever first-type radio link quality assessed based on the first reference signal resource set is worse than a first threshold, increasing a first counter by 1; then transmitting a first radio signal for beam management, the first radio signal indicating a first reference signal resource; determining a second reference signal resource set from a first candidate reference signal resource pool based on at least the first reference signal resource; as a response to the first counter reaching a first value, transmitting a second radio signal, the second radio signal being used for beam failure recovery, and the second radio signal indicating a second reference signal resource; the second reference signal resource belonging to the second reference signal resource set.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: first transmits a first message, the first message is used to determine a first reference signal resource set, the first reference signal resource set comprises at least one reference signal resource; a receiver of the first message comprises a first node; whenever first-type radio link quality assessed by the first node based on the first reference signal resource set is worse than a first threshold, increases a first counter by 1; then receives a first radio signal for beam management, the first radio signal indicates a first reference signal resource; the first node determines a second reference signal resource set from a first candidate reference signal resource pool based on at least the first reference signal resource; receives a second radio signal, the second radio signal is used for beam failure recovery, and the second radio signal indicates a second reference signal resource; the second reference signal resource belongs to the second reference signal resource set, and the first node transmits the second radio signal as a response to the first counter reaching a first value.

In one embodiment, the second communication device 410 comprises a memory that stores a computer readable instruction program. The computer readable instruction program generates an action when executed by at least one processor. The action includes: first transmitting a first message, the first message being used to determine a first reference signal resource set, the first reference signal resource set comprising at least one reference signal resource; a receiver of the first message comprising a first node; whenever first-type radio link quality assessed by the first node based on the first reference signal resource set is worse than a first threshold, increasing a first counter by 1; then receiving a first radio signal for beam management, the first radio signal indicating a first reference signal resource; the first node determining a second reference signal resource set from a first candidate reference signal resource pool based on at least the first reference signal resource; receiving a second radio signal, the second radio signal being used for beam failure recovery, and the second radio signal indicating a second reference signal resource; the second reference signal resource belonging to the second reference signal resource set, and the first node transmitting the second radio signal as a response to the first counter reaching a first value.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a terminal.

In one embodiment, the first communication device 450 can identify multiple TRPs under a base station.

In one embodiment, the second communication device 410 is a base station.

In one embodiment, the second communication device 410 is a UE.

In one embodiment, the second communication device 410 is a network device.

In one embodiment, the second communication device 410 is a serving cell.

In one embodiment, the second communication device 410 is a TRP.

In one embodiment, the second communication device 410 supports maintaining multiple TRPs.

In one embodiment, at least first four of the antenna 452, the receiver 454, the multi-antenna receiving processor 458, the receiving processor 456 and the controller/processor 459 are used to receive a first message, the first message is used to determine a first reference signal resource set, and the first reference signal resource set comprises at least one reference signal resource; at least first four of the antenna 420, the transmitter 418, the multi-antenna transmitting processor 471, the transmitting processor 416 and the controller/processor 475 are used to transmit a first message, the first message is used to determine a first reference signal resource set, and the first reference signal resource set comprises at least one reference signal resource.

In one embodiment, at least first four of the antenna 452, the receiver 454, the multi-antenna receiving processor 458, the receiving processor 456 and the controller/processor 459 are used to assess first-type radio link quality according to the first reference signal resource set, whenever first-type radio link quality assessed based on the first reference signal resource set is worse than a first threshold, a first counter is increased by 1.

In one embodiment, at least first four of the antenna 452, the transmitter 454, the multi-antenna transmitting processor 457, the transmitting processor 468, and the controller/processor 459 are used to transmit a first radio signal for beam management; at least first four of the antenna 420, the receiver 418, the multi-antenna receiving processor 472, the receiving processor 470 and the controller/processor 475 are used to receive a first radio signal for beam management.

In one embodiment, at least first four of the antenna 452, the transmitter 454, the multi-antenna transmitting processor 457, the transmitting processor 468, and the controller/processor 459 are used to determine a second reference signal resource set from a first candidate reference signal resource pool based on at least the first reference signal resource; at least the first four of the antenna 420, the receiver 418, the multi-antenna receiving processor 472, the receiving processor 470, and the controller/processor 475 are used to determine a second reference signal resource set from a first candidate reference signal resource pool based on at least the first reference signal resource.

In one embodiment, at least first four of the antenna 452, the transmitter 454, the multi-antenna transmitting processor 457, the transmitting processor 468, and the controller/processor 459 are used to transmit a second radio signal; at least first four of the antenna 420, the receiver 418, the multi-antenna receiving processor 472, the receiving processor 470 and the controller/processor 475 are used to receive a second radio signal.

In one embodiment, at least first four of the antenna 452, the receiver 454, the multi-antenna receiving processor 458, the receiving processor 456 and the controller/processor 459 are used to receive first signaling; at least first four of the antenna 420, the transmitter 418, the multi-antenna transmitting processor 471, the transmitting processor 416 and the controller/processor 475 are used to transmit a first signaling.

In one embodiment, at least first four of the antenna 452, the receiver 454, the multi-antenna receiving processor 458, the receiving processor 456 and the controller/processor 459 are used to receive a second signaling in a first time-frequency resource set; at least first four of the antenna 420, the transmitter 418, the multi-antenna transmitting processor 471, the transmitting processor 416 and the controller/processor 475 are used to transmit a second signaling in a first candidate resource set.

In one embodiment, at least first four of the antenna 452, the receiver 454, the multi-antenna receiving processor 458, the receiving processor 456 and the controller/processor 459 are used to update reference signal resources associated with a first TCI state as the first reference signal resource; at least first four of the antenna 420, the transmitter 418, the multi-antenna transmitting processor 471, the transmitting processor 416 and the controller/processor 475 are used to update reference signal resources associated with a first TCI state as the first reference signal resource.

In one embodiment, at least first four of the antenna 452, the receiver 454, the multi-antenna receiving processor 458, the receiving processor 456 and the controller/processor 459 are used to update the second reference signal resource into the first candidate reference signal resource pool; at least first four of the antenna 420, the transmitter 418, the multi-antenna transmitting processor 471, the transmitting processor 416 and the controller/processor 475 are used to update the second reference signal resource into the first candidate reference signal resource pool.

### Embodiment 5

Embodiment 5 illustrates a flowchart of a first message, as shown in FIG. 5. In FIG. 5, a first node U1 and a second node N2 are in communications via a radio link. It is particularly underlined that the order illustrated in the embodiment does not put constraints over sequences of signal transmissions and implementations. Embodiments, sub-embodiments and subsidiary embodiments of embodiment 5 can be applied to any of embodiment 6 or embodiment 7 if no conflict is caused; conversely, embodiments, sub-embodiments, and subsidiary embodiments of either of embodiment 6 or embodiment 7 can be applied to embodiment 5 without conflict.

The first node U1 receives a first message in step S10; whenever first-type radio link quality assessed based on the first reference signal resource set is worse than a first threshold in step S11, increases a first counter by 1; transmits a first radio signal in step S12; as a response to the first counter reaching a first value in step S13, transmits a second radio signal.

The second node N2 transmits a first message in step S20; receives a first radio signal in step S21; receives a second radio signal in step S22.

In embodiment 5, the first message is used to determine a first reference signal resource set, the first reference signal resource set comprises at least one reference signal resource; the first radio signal belongs to a beam management procedure; the second radio signal is used for beam failure recovery, and the second radio signal indicates a second reference signal resource; the second reference signal resource belongs to the second reference signal resource set.

In one embodiment, the first node U1 determines a second reference signal resource set from a first candidate reference signal resource pool based on at least the first reference signal resource.

In one embodiment, the second node N2 determines a second reference signal resource set from a first candidate reference signal resource pool based on at least the first reference signal resource.

In one embodiment, the first candidate reference signal resource pool comprises a first candidate reference signal resource set and a second candidate reference signal resource set; the first candidate reference signal resource set and the second candidate reference signal resource set are respectively associated with a first PCI and a second PCI; when the first reference signal resource is associated with the first PCI, the second reference signal resource set is the first candidate reference signal resource set; when the first reference signal resource is associated with the second PCI, the second reference signal resource set is the second candidate reference signal resource set.

In one subembodiment of the embodiment, the meaning of the above phrase that the first reference signal resource is associated with the first PCI comprises: an RRC signaling for configuring the first reference signal resource comprises the first PCI.

In one subembodiment of the embodiment, the meaning of the above phrase that the first reference signal resource is associated with the first PCI mentioned in the above phrase comprises: the first reference signal resource is transmitted by a TRP corresponding to the first PCI.

In one subembodiment of the embodiment, the meaning of the above phrase that the first reference signal resource is associated with the first PCI comprises: the first reference signal resource is maintained by a TRP corresponding to the first PCI.

In one subembodiment of the embodiment, the meaning of the phrase that the first reference signal resource is associated with the second PCI comprises: an RRC signaling for configuring the first reference signal resource comprises the second PCI.

In one subembodiment of the embodiment, the meaning of the phrase that the first reference signal resource is associated with the second PCI comprises: the first reference signal resource is transmitted by a TRP corresponding to the second PCI.

In one subembodiment of the embodiment, the meaning of the phrase that the first reference signal resource is associated with the second PCI comprises: the first reference signal resource is maintained by a TRP corresponding to the second PCI.

In one subembodiment of the embodiment, the phrase that the first candidate reference signal resource set is associated with a first PCI comprises: each reference signal resource in the first candidate reference signal resource set is associated with the first PCI.

In one subembodiment of the embodiment, the phrase that the first candidate reference signal resource set is associated with a first PCI comprises: all reference signal resources in the first candidate reference signal resource set are associated with the first PCI.

In one subembodiment of the embodiment, the phrase that the first candidate reference signal resource set is associated with a first PCI comprises: the first candidate reference signal resource set is for a cell identified by the first PCI.

In one subembodiment of the embodiment, the phrase that the first candidate reference signal resource set is associated with a first PCI comprises: the first candidate reference signal resource set is associated with at least one TRP in the first PCI.

In one subembodiment of the embodiment, the phrase that the first candidate reference signal resource set is associated with a first PCI comprises: the first candidate reference signal resource set is only associated with a TRP in the first PCI.

In one subembodiment of the embodiment, the phrase that the first candidate reference signal resource set is associated with a first PCI comprises: the first candidate reference signal resource set is associated with all TRPs in the first PCI.

In one subembodiment of the embodiment, the phrase that the second candidate reference signal resource set is associated with a second PCI comprises: each reference signal resource in the second candidate reference signal resource set is associated with the second PCI.

In one subembodiment of the embodiment, the phrase that the second candidate reference signal resource set is associated with a second PCI comprises: all reference signal resources in the second candidate reference signal resource set are associated with the second PCI.

In one subembodiment of the embodiment, the phrase that the second candidate reference signal resource set is associated with a second PCI comprises: the second candidate reference signal resource set is for a cell identified by the second PCI.

In one embodiment, the phrase that the second candidate reference signal resource set is associated with a second PCI comprises: the second candidate reference signal resource set is associated with at least one TRP in the second PCI.

In one embodiment, the phrase that the second candidate reference signal resource set is associated with a second PCI comprises: the second candidate reference signal resource set is only associated with a TRP in the second PCI.

In one subembodiment of the embodiment, the phrase that the second candidate reference signal resource set is associated with a second PCI comprises: the second candidate reference signal resource set is associated with all TRPs in the second PCI.

In one subembodiment of the embodiment, the first candidate reference signal resource set comprises M2 reference signal resources, M2 being a positive integer greater than one.

In one subsidiary embodiment of the subembodiment, at least one of the M2 reference signal resources is a CSI-RS resource.

In one subsidiary embodiment of the subembodiment, at least one of the M2 reference signal resources is an SSB resource.

In one subsidiary embodiment of the subembodiment, at least one of the M2 reference signal resources is an SS/PBCH block.

In one subsidiary embodiment of the subembodiment, at least one of the M2 reference signal resources corresponds to a TCI-State.

In one subsidiary embodiment of the subembodiment, at least one of the M2 reference signal resources corresponds to a TCI-StateId.

In one subsidiary embodiment of the subembodiment, any of the M2 reference signal resources is periodic.

In one subsidiary embodiment of the subembodiment, any of the M2 reference signal resources is aperiodic.

In one subsidiary embodiment of the subembodiment, any of the M2 reference signal resources is QCL-Type D.

In one subsidiary embodiment of the subembodiment, one of the M2 reference signal resources is a CSI-RS resource identified by csi-RS-Index, or the reference signal resource is an SSB resource identified by ssb-Index.

In one subsidiary embodiment of the subembodiment, one of the M2 reference signal resources is a CSI-RS resource identified by csi-rs, or the reference signal resource is an SSB resource identified by ssb.

In one subsidiary embodiment of the subembodiment, one reference signal resource in M2 reference signal resources set is a CSI-RS resource identified by NZP-CSI-RS-ResourceId, or the reference signal resource is an SSB resource identified by SSB-Index.

In one subembodiment of the embodiment, the second candidate reference signal resource set comprises M3 reference signal resources, M3 being a positive integer greater than one.

In one subsidiary embodiment of the subembodiment, at least one of the M3 reference signal resources is a CSI-RS resource.

In one subsidiary embodiment of the subembodiment, at least one of the M3 reference signal resources is an SSB resource.

In one subsidiary embodiment of the subembodiment, at least one of the M3 reference signal resources is an SS/PBCH block.

In one subsidiary embodiment of the subembodiment, at least one of the M3 reference signal resources corresponds to a TCI-State.

In one subsidiary embodiment of the subembodiment, at least one of the M3 reference signal resources corresponds to a TCI-StateId.

In one subsidiary embodiment of the subembodiment, any of the M3 reference signal resources is periodic.

In one subsidiary embodiment of the subembodiment, any of the M3 reference signal resources is aperiodic.

In one subsidiary embodiment of the subembodiment, any of the M3 reference signal resources is QCL-Type D.

In one subsidiary embodiment of the subembodiment, one of the M3 reference signal resources is a CSI-RS resource identified by csi-RS-Index, or the reference signal resource is an SSB resource identified by ssb-Index.

In one subsidiary embodiment of the subembodiment, one of the M3 reference signal resources is a CSI-RS resource identified by csi-rs, or the reference signal resource is an SSB resource identified by ssb.

In one subsidiary embodiment of the subembodiment, one reference signal resource in M3 reference signal resources set is a CSI-RS resource identified by NZP-CSI-RS-ResourceId, or the reference signal resource is an SSB resource identified by SSB-Index.

In one subembodiment of the embodiment, the first PCI is a non-negative integer.

In one subembodiment of the embodiment, the second PCI is a non-negative integer.

In one embodiment, the second reference signal resource is the first reference signal resource.

In one subembodiment of the embodiment, the meaning of the above phrase that the second reference signal resource is the first reference signal resource comprises: a reference signal corresponding to the second reference signal resource and a reference signal corresponding to the first reference signal resource occupy same time-frequency resources.

In one subembodiment of the embodiment, the meaning of the above phrase that the second reference signal resource is the first reference signal resource comprises: a TCI-StateId corresponding to the second reference signal resource is the same as a TCI-StateId corresponding to the first reference signal resource.

In one subembodiment of the embodiment, the meaning of the above phrase that the second reference signal resource is the first reference signal resource comprises: the second reference signal resource and the first reference signal resource are QCL.

In one subembodiment of the embodiment, the meaning of the above phrase that the second reference signal resource is the first reference signal resource comprises: a second identifier corresponding to the second reference signal resource is related to a first identifier corresponding to the first reference signal resource.

In one subsidiary embodiment of the subembodiment, the meaning that the second identifier is related to the first identifier comprises: the second identifier is the same as the first identifier.

In one subsidiary embodiment of the subembodiment, the meaning that the second identifier is related to the first identifier comprises: the second identifier and the first identifier belong to same QCL-Info in a same TCI-State IE.

In one subsidiary embodiment of the subembodiment, the first identifier is one of NZP-CSI-RS-ResourceId or SSB-Index.

In one subsidiary embodiment of the subembodiment, the second identifier is one of NZP-CSI-RS-ResourceId or SSB-Index.

In one embodiment, the first node U1 updates reference signal resources associated with a first TCI state as the first reference signal resource, and the first radio signal is used to determine the first TCI state.

In one embodiment, the second node N2 updates reference signal resources associated with a first TCI state as the first reference signal resource, and the first radio signal is used to determine the first TCI state.

In one subembodiment of the above two embodiments, before the first node U1 transmits the first radio signal, the first TCI state is associated with reference signal resources other than the first reference signal resource.

In one subembodiment of the above two embodiments, before the second node N2 receives the first radio signal, the first TCI state is associated with reference signal resources other than the first reference signal resource.

In one subembodiment of the above two embodiments, the first TCI state corresponds to a TCI-StateId.

In one subembodiment of the above two embodiments, the operation of updating reference signal resources associated with a first TCI state to the first reference signal resource is completed at the first node.

In one subembodiment of the above two embodiments, before the first node U1 updates reference signal resources associated with a first TCI state as the first reference signal resource, there is no need to wait for a confirmation from the second node N2 for the first radio signal.

In one subembodiment of the above two embodiments, before the first node U1 updates reference signal resources associated with a first TCI state as the first reference signal resource, there is no need to wait for the first signaling in the present application.

In one subembodiment of the above two embodiments, the first radio signal is used to indicate the first TCI.

In one embodiment, when the first node U1 transmits the second radio signal, the second reference signal resource is updated into the first candidate reference signal resource pool.

In one embodiment, when the second node N2 receives the second radio signal, the second reference signal resource is updated into the first candidate reference signal resource pool.

In one subembodiment of the above two embodiments, the meaning of the above phrase that the second reference signal resource is updated into the first candidate reference signal resource pool comprises: the second reference signal resource is added into the first candidate reference signal resource pool.

In one subembodiment of the above two embodiments, the meaning of the above phrase that the second reference signal resource is updated into the first candidate reference signal resource pool comprises: the second reference signal resource is added into the first candidate reference signal resource pool.

In one subembodiment of the above two embodiments, the meaning of the above phrase that the second reference signal resource is updated into the first candidate reference signal resource pool comprises: the first candidate reference signal resource pool comprises a first candidate reference signal resource set and a second candidate reference signal resource set; the first candidate reference signal resource set and the second candidate reference signal resource set are respectively associated with a first PCI and a second PCI; when the first reference signal resource is associated with the first PCI, the second reference signal resource is added into the first candidate reference signal resource set.

### Embodiment 6

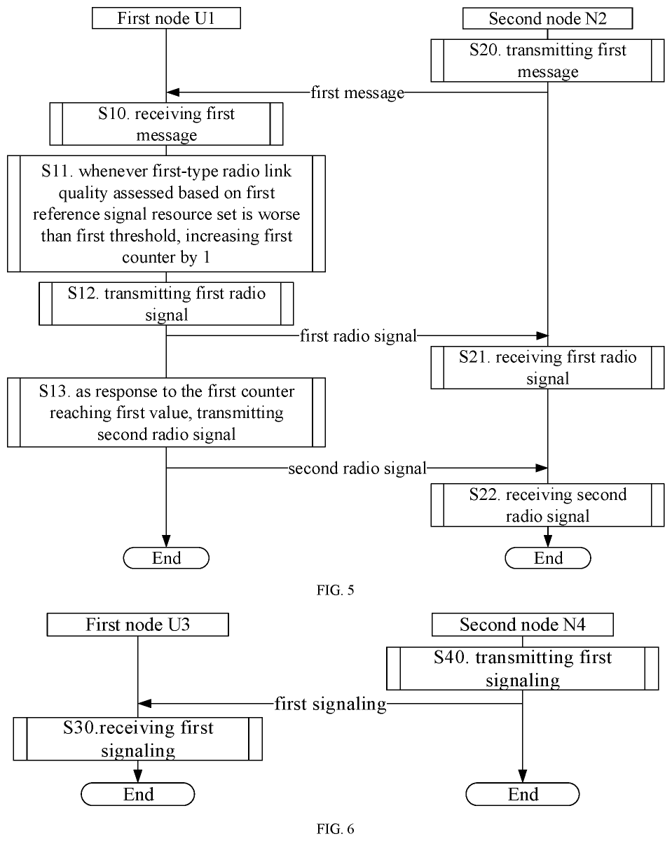

Embodiment 6 illustrates a flowchart of a first signaling, as shown in FIG. 6. In FIG. 6, a first node U3 and a second node N4 are in communications via a radio link. It is particularly underlined that the order illustrated in the embodiment does not put constraints over sequences of signal transmissions and implementations. Embodiments, subembodiments and subsidiary embodiments of embodiment 6 can be applied to any of embodiment 5 or embodiment 7 if no conflict is caused; and vice versa, any of embodiments, subembodiments, and subsidiary embodiments of embodiment 5 or 7 can be applied to embodiment 6 if no conflict is caused.

The first node U3 receives a first signaling in step S30.

The second node N4 transmits a first signaling in step S40.

In embodiment 6, the first signaling is used to determine that a demodulation reference signal of a PDCCH in CORESET 0 and a first reference signal resource are QCL.

In one embodiment, the step S30 in embodiment 6 takes after step S12 in embodiment 5 and before step S13.

In one embodiment, step S30 in embodiment 6 takes after step S13 in embodiment 5.

In one embodiment, the step S40 in embodiment 6 takes after step S21 in embodiment 5 and before step S22.

In one embodiment, the step S40 in embodiment 6 takes after step S22 in embodiment 5.

In one embodiment, the meaning of the phrase that the first time-frequency resource set is associated with CORESET 0 comprises: frequency-domain resources occupied by the first time-frequency resource set belong to frequency-domain resources occupied by the CORESET 0.

In one embodiment, the meaning of the phrase that the first time-frequency resource set is associated with CORESET 0 comprises: a symbol occupied by the first time-frequency resource set belongs to a symbol occupied by the CORESET 0.

In one embodiment, the meaning of the phrase that the first time-frequency resource set is associated with CORESET 0 comprises: a slot where the first time-frequency resource set is located belongs to a slot occupied by search space associated with the CORESET 0.

In one embodiment, the first signaling is used to indicate that a demodulation reference signal of a PDCCH in CORESET 0 and a first reference signal resource are QCL.

In one embodiment, the first signaling is a HARQ-ACK for the first radio signal.

In one embodiment, the first signaling is a MAC CE.

In one embodiment, a physical-layer channel occupied by the first signaling comprises a PDCCH.

In one embodiment, a type of the QCL in the present application comprises QCL Type A.

In one embodiment, a type of the QCL in the present application comprises QCL Type B.

In one embodiment, a type of the QCL in the present application comprises QCL Type C.

In one embodiment, a type of the QCL in the present application comprises QCL Type D.

In one embodiment, the beam management in the present application comprises receiving the first signaling.

In one embodiment, when the first node U3 receives the first signaling, the first node U3 determines the second reference signal resource set from the first candidate reference signal resource pool based on the first reference signal resource.

### Embodiment 7

Embodiment 7 illustrates a flowchart of a second signaling, as shown in FIG. 7. In FIG. 7, a first node U5 and a second node N6 are in communications via a radio link. It is particularly underlined that the order illustrated in the embodiment does not put constraints over sequences of signal transmissions and implementations. Embodiments, sub-embodiments and subsidiary embodiments in embodiment 7 can be applied to any of embodiment 5 or embodiment 6 if no conflict is caused; and vice versa, any of embodiments, subembodiments, and subsidiary embodiments of embodiment 5 or 6 can be applied to embodiment 7 if no conflict is caused.

The first node U5 receives a second signaling in a first time-frequency resource set in step S50.

The second node N6 transmits a second signaling in a first time-frequency resource set in step S60.

In embodiment 7, the first time-frequency resource set is associated with CORESET 0, and the second reference signal resource and a demodulation reference signal comprised in the second time-frequency resource set are QCL.

In one embodiment, step S50 in embodiment 7 takes after step S13 in embodiment 5.

In one embodiment, step S60 in embodiment 7 takes after step S22 in embodiment 5.

In one embodiment, the symbol in the present application is an Orthogonal Frequency Division Multiplexing (OFDM) symbol.

In one embodiment, the symbol in the present application is a Single Carrier-Frequency Division Multiple Access (SC-FDMA) symbol.

In one embodiment, the symbol in the present application is a Filter Bank Multi Carrier (FBMC) symbol.

In one embodiment, the symbol in the present application is an OFDM symbol that comprises a Cyclic Prefix (CP).

In one embodiment, the symbol in the present application is a Discrete Fourier Transform Spreading Orthogonal Frequency Division Multiplexing (DFT-s-OFDM) symbol that comprises a CP.

In one embodiment, the first time-frequency resource set occupies frequency-domain resources corresponding to a positive integer number of RB(s) (Resource Block(s)) in frequency domain, and the first time-frequency resource set occupies a positive integer number of symbol(s) in time domain.

In one embodiment, the first time-frequency resource set occupies more than one RE.

In one embodiment, the first node U5 receives the second signaling in the first time-frequency resource set after transmitting the second radio signal.

In one embodiment, after transmitting the second radio signal, the first node U5 assumes that a demodulation reference signal of a PDCCH in CORESET 0 is QCL with the second reference signal resource.

In one embodiment, when and only when the second reference signal resource set is the first candidate reference signal resource set, the first node U5 assumes that a demodulation reference signal of a PDCCH in CORESET 0 is QCL with the second reference signal resource.

### Embodiment 8

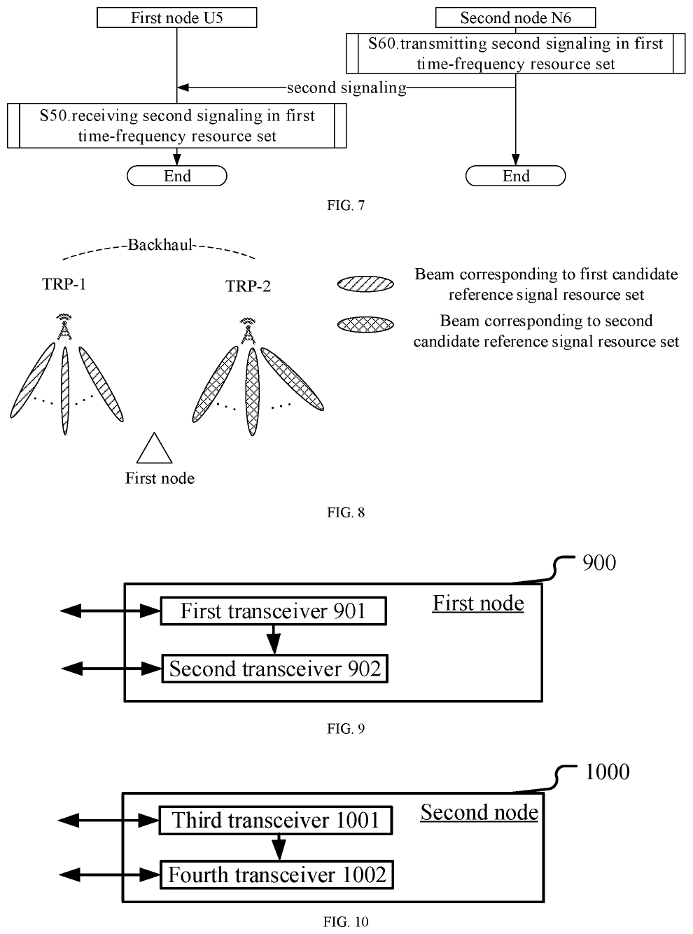

Embodiment 8 illustrates a schematic diagram of an application scenario, as shown in FIG. 8. In FIG. 8, both TRP-1 and TRP-2 shown in the figure are managed by the second node in the present application; the first PCI in the present application is associated with the TRP-1, and the second PCI in the present application is associated with the TRP-2; the first node moves within the coverage range of the TRP-1 and the coverage range of the TRP-2.

In one embodiment, when the first node moves from the coverage range of the TRP-1 to the coverage range of the TRP-2, the first reference signal resource is one in the second candidate reference signal resource set.

In one embodiment, when the first node moves from the coverage range of the TRP-1 to the coverage range of the TRP-2, the second reference signal resource is one in the second candidate reference signal resource set.

In one embodiment, when the first node moves from the coverage range of the TRP-2 to the coverage range of the TRP-1, the first reference signal resource is one in the first candidate reference signal resource set.

In one embodiment, when the first node moves from the coverage range of the TRP-2 to the coverage range of the TRP-1, the second reference signal resource is one in the first candidate reference signal resource set.

### Embodiment 9

Embodiment 9 illustrates a structure block diagram in a first node, as shown in FIG. 9. In FIG. 9, a first node 900 comprises a first transceiver 901 and a second transceiver 902.

The first transceiver 901 receives a first message, the first message is used to determine a first reference signal resource set, the first reference signal resource set comprises at least one reference signal resource; whenever first-type radio link quality assessed based on the first reference signal resource set is worse than a first threshold, increases a first counter by 1;

the second transceiver 902 transmits a first radio signal for beam management, the first radio signal indicates a first reference signal resource; determines a second reference signal resource set from a first candidate reference signal resource pool based on at least the first reference signal resource; as a response to the first counter reaching a first value, transmits a second radio signal, the second radio signal is used for beam failure recovery, and the second radio signal indicates a second reference signal resource.

In embodiment 9, the second reference signal resource belongs to the second reference signal resource set.

In one embodiment, the first candidate reference signal resource pool comprises a first candidate reference signal resource set and a second candidate reference signal resource set; the first candidate reference signal resource set and the second candidate reference signal resource set are respectively associated with a first PCI and a second PCI; when the first reference signal resource is associated with the first PCI, the second reference signal resource set is the first candidate reference signal resource set; when the first reference signal resource is associated with the second PCI, the second reference signal resource set is the second candidate reference signal resource set.

In one embodiment, the second transceiver 902 receives a first signal, and the first signaling is used to determine that a demodulation reference signal of a PDCCH in CORESET 0 and the first reference signal resource are QCL.

In one embodiment, the second transceiver 902 receives a second signaling in a first time-frequency resource set, the first time-frequency resource set is associated with CORESET 0, and the second reference signal resource and a demodulation reference signal comprised in the second time-frequency resource set are QCL.

In one embodiment, the second reference signal resource is the first reference signal resource, or the second reference signal resource and the first reference signal resource are QCL.

In one embodiment, the first node updates reference signal resources associated with a first TCI state to the first reference signal resource, and the first radio signal is used to determine the first TCI state.

In one embodiment, when the first node transmits the second radio signal, the second reference signal resource is updated into the first candidate reference signal resource pool.

In one embodiment, the first transceiver 1901 comprises at least first six of the antenna 452, the receiver/transmitter 454, the multi-antenna receiving processor 458, the multi-antenna transmitting processor 457, the receiving processor 456, the transmitting processor 468, and the controller/processor 459 in embodiment 4.

In one embodiment, the second transceiver 1902 comprises at least first six of the antenna 452, the receiver/transmitter 454, the multi-antenna receiving processor 458, the multi-antenna transmitting processor 457, the receiving processor 456, the transmitting processor 468, and the controller/processor 459 in embodiment 4.

### Embodiment 10

Embodiment 10 illustrates a structure block diagram in a second node, as shown in FIG. 10. In FIG. 10, a second node 1000 comprises a third transceiver 1001 and a fourth receiver 1002.

The third transceiver 1001 transmits a first message, the first message is used to determine a first reference signal resource set, and the first reference signal resource set comprises at least one reference signal resource; a receiver of the first message comprises a first node; whenever first-type radio link quality assessed by the first node based on the first reference signal resource set is worse than a first threshold, increases a first counter by 1;

the fourth transceiver 1002 receives a first radio signal for beam management, the first radio signal indicates a first reference signal resource; the first node determines a second reference signal resource set from a first candidate reference signal resource pool based on at least the first reference signal resource; transmits a second radio signal, the second radio signal is used for beam failure recovery, and the second radio signal indicates a second reference signal resource;

In embodiment 10, the second reference signal resource belongs to the second reference signal resource set, and the first node transmits the second radio signal as a response to the first counter reaching a first value.

In one embodiment, the first candidate reference signal resource pool comprises a first candidate reference signal resource set and a second candidate reference signal resource set; the first candidate reference signal resource set and the second candidate reference signal resource set are respectively associated with a first PCI and a second PCI; when the first reference signal resource is associated with the first PCI, the second reference signal resource set is the first candidate reference signal resource set; when the first reference signal resource is associated with the second PCI, the second reference signal resource set is the second candidate reference signal resource set.

In one embodiment, the fourth transceiver 1002 transmits a first signaling; the first signaling is used to determine that a demodulation reference signal of a PDCCH in CORESET 0 and a first reference signal resource are QCL.

In one embodiment, the fourth transceiver 1002 transmits a second signaling in a first time-frequency resource set; the first time-frequency resource set is associated with CORESET 0, and the second reference signal resource and a demodulation reference signal comprised in the second time-frequency resource set are QCL.

In one embodiment, the second reference signal resource is the first reference signal resource, or the second reference signal resource and the first reference signal resource are QCL.

In one embodiment, the second node updates reference signal resources associated with a first TCI state to the first reference signal resource; the first radio signal is used to determine the first TCI state.

In one embodiment, when the second node receives the second radio signal, the second reference signal resource is updated into the first candidate reference signal resource pool.

In one embodiment, the third transceiver 1101 comprises at least first six of the antenna 420, the transmitter/receiver 418, the multi-antenna transmitting processor 471, the multi-antenna receiving processor 472, the transmitting processor 416, the receiving processor 470, and the controller/processor 475 in embodiment 4.

In one embodiment, the fourth transceiver 1002 comprises at least first six of the antenna 420, the transmitter/receiver 418, the multi-antenna transmitting processor 471, the multi-antenna receiving processor 472, the transmitting processor 416, the receiving processor 470, and the controller/processor 475 in embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, vehicles, cars, RSUs, aircrafts, diminutive airplanes, unmanned aerial vehicles, telecontrolled aircrafts and other wireless communication devices. The second node in the present application includes but is not limited to macro-cellular base stations, femtocell, micro-cellular base stations, home base stations, relay base station, eNB, gNB, Transmitter Receiver Point (TRP), GNSS, relay satellites, satellite base stations, space base stations, RSUs, Unmanned Aerial Vehicle (UAV), test devices, for example, a transceiver or a signaling tester simulating some functions of a base station and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first transceiver, receiving a first message, the first message being used to determine a first reference signal resource set, the first reference signal resource set comprising at least one reference signal resource; whenever first-type radio link quality assessed based on the first reference signal resource set is worse than a first threshold, increasing a first counter by 1; and
a second transceiver, transmitting a first radio signal for beam management, the first radio signal indicating a first reference signal resource; determining a second reference signal resource set from a first candidate reference signal resource pool based on at least the first reference signal resource; as a response to the first counter reaching a first value, transmitting a second radio signal, the second radio signal being used for beam failure recovery, and the second radio signal indicating a second reference signal resource;
wherein the second reference signal resource belongs to the second reference signal resource set.

2. The first node according to claim 1, wherein the first candidate reference signal resource pool comprises a first candidate reference signal resource set and a second candidate reference signal resource set; the first candidate reference signal resource set and the second candidate reference signal resource set are respectively associated with a first PCI (Physical Cell Identifier) and a second PCI; when the first reference signal resource is associated with the first PCI, the second reference signal resource set is the first candidate reference signal resource set; when the first reference signal resource is associated with the second PCI, the second reference signal resource set is the second candidate reference signal resource set.

3. The first node according to claim 1, wherein the second transceiver receives a first signal, and the first signaling is used to determine that a demodulation reference signal of a PDCCH (Physical Downlink Control Channel) in CORESET 0 and the first reference signal resource are QCL (quasi co-located).

4. The first node according to claim 1, wherein the second transceiver receives a second signaling in a first time-frequency resource set, the first time-frequency resource set is associated with CORESET 0 (Control Resource Set 0), and the second reference signal resource and a demodulation reference signal comprised in the second time-frequency resource set are QCL.

5. The first node according to claim 1, wherein the second reference signal resource is the first reference signal resource, or the second reference signal resource and the first reference signal resource are QCL.

6. The first node according to claim 1, wherein reference signal resources associated with a first TCI (Transmission Configuration Indicator) state are updated to the first reference signal resource, and the first radio signal is used to determine the first TCI state.

7. The first node according to claim 1, wherein when the first node transmits the second radio signal, the second reference signal resource is updated into the first candidate reference signal resource pool.

8. The first node according to claim 1, wherein the beam management does not belong to the beam failure detection and recovery procedure;
or beam management does not comprise receiving an indication from lower layer;
or the beam management does not comprise starting or restarting a timer as a response to receiving an indication from lower layer;
or the beam management does not comprise that when first-type radio link quality assessed based on the first reference signal resource set is worse than a first threshold, a first counter is increased by 1.

9. The first node according to claim 1, wherein the beam management comprises changing a TCI state of a physical channel,
or, the beam management comprises changing a TCI state corresponding to a CORESET of a physical channel,
or, the beam management comprises changing a corresponding relation between a TCI and a reference signal resource,
or, the beam management comprises CSI (Channel State Information) reporting.

10. The first node according to claim 1, wherein the feedback for the first radio signal comprises a HARQ-ACK (Hybrid Automatic Repeat reQuest Acknowledgement),
or, the feedback for the first radio signal comprises a PDCCH (Physical Downlink Control Channel),
or, the feedback for the first radio signal comprises a MAC (Medium Access Control) CE (Control Element).

11. A second node for wireless communications, comprising:
a third transceiver, transmitting a first message, the first message being used to determine a first reference signal resource set, the first reference signal resource set comprising at least one reference signal resource; a receiver of the first message comprising a first node; whenever first-type radio link quality assessed by the first node based on the first reference signal resource set is worse than a first threshold, increasing a first counter by 1; and
a fourth transceiver, receiving a first radio signal for beam management, the first radio signal indicating a first reference signal resource; the first node determining a second reference signal resource set from a first candidate reference signal resource pool based on at least the first reference signal resource; receiving a second radio signal, the second radio signal being used for beam failure recovery, and the second radio signal indicating a second reference signal resource;
wherein the second reference signal resource belongs to the second reference signal resource set, and the first node transmits the second radio signal as a response to the first counter reaching a first value.

12. The second node according to claim 11, wherein the first candidate reference signal resource pool comprises a first candidate reference signal resource set and a second candidate reference signal resource set; the first candidate reference signal resource set and the second candidate reference signal resource set are respectively associated with a first PCI and a second PCI; when the first reference signal resource is associated with the first PCI, the second reference signal resource set is the first candidate reference signal resource set; when the first reference signal resource is associated with the second PCI, the second reference signal resource set is the second candidate reference signal resource set.

13. The second node according to claim 11, wherein the fourth transceiver transmits a first signaling, and the first signaling is used to determine that a demodulation reference signal of a PDCCH in CORESET 0 and the first reference signal resource are QCL.

14. The second node according to claim 11, wherein the fourth transceiver transmits a second signaling in a first time-frequency resource set, the first time-frequency resource set is associated with CORESET 0, and the second reference signal resource and a demodulation reference signal comprised in the second time-frequency resource set are QCL.

15. The second node according to claim 11, wherein the second reference signal resource is the first reference signal resource, or the second reference signal resource and the first reference signal resource are QCL.

16. The second node according to claim 11, wherein reference signal resources associated with a first TCI state are updated to the first reference signal resource, and the first radio signal is used to determine the first TCI state.

17. The second node according to claim 11, wherein when the second node receives the second radio signal, the second reference signal resource is updated into the first candidate reference signal resource pool.

18. A method in a first node for wireless communications, comprising:
receiving a first message, the first message being used to determine a first reference signal resource set, the first reference signal resource set comprising at least one reference signal resource; whenever first-type radio link quality assessed based on the first reference signal resource set is worse than a first threshold, increasing a first counter by 1; and
transmitting a first radio signal for beam management, the first radio signal indicating a first reference signal resource; determining a second reference signal resource set from a first candidate reference signal resource pool based on at least the first reference signal resource; as a response to the first counter reaching a first value, transmitting a second radio signal, the second radio signal being used for beam failure recovery, and the second radio signal indicating a second reference signal resource;
wherein the second reference signal resource belongs to the second reference signal resource set.

19. The method in a first node according to claim 18, wherein the first candidate reference signal resource pool comprises a first candidate reference signal resource set and a second candidate reference signal resource set; the first candidate reference signal resource set and the second candidate reference signal resource set are respectively associated with a first PCI and a second PCI; when the first reference signal resource is associated with the first PCI, the second reference signal resource set is the first candidate reference signal resource set; when the first reference signal resource is associated with the second PCI, the second reference signal resource set is the second candidate reference signal resource set.

20. The method in a first node according to claim 18, comprising:
receiving a first signaling;
wherein the first signaling is used to determine that a demodulation reference signal of a PDCCH in CORESET 0 and a first reference signal resource are QCL.
